(19) United States
(12) Patent Application Publication
(10) Pub. No.: US 2016/0171426 A1
(43) Pub. Date: Jun. 16, 2016

(54) COMMODITY PROCESSING SYSTEM

(71) Applicant: CASIO COMPUTER CO., LTD., Tokyo (JP)

(72) Inventors: Masaki FUJIMOTO, Tokyo (JP); Taro EJIRI, Tokyo (JP); Hideo SUZUKI, Tokyo (JP); Hiroshi AKAO, Tokyo (JP); Kiyoshi OGISHIMA, Tokyo (JP)

(73) Assignee: CASIO COMPUTER CO., LTD., Tokyo (JP)

(21) Appl. No.: 14/925,094

(22) Filed: Oct. 28, 2015

(30) Foreign Application Priority Data
Dec. 10, 2014 (JP) 2014-249591

(51) Int. Cl. G06Q 10/08; G06Q 20/20; G07G 1/00

(52) U.S. Cl. CPC G06Q 10/08; G07G 1/0018; G07G 1/0036; G06Q 20/208

(57) ABSTRACT

A commodity processing system, includes: a commodity identification unit that identifies a target being conveyed in a predetermined conveyance direction by a conveyance unit as a commodity based on image information acquired from a taken image of the target and/or an identification label attached to the target; and a driving control unit that, when the commodity identification unit cannot identify the target as a commodity, stops conveyance of the target by the conveyance unit when the target moves to a predetermined position in the conveyance direction.

### CROSS-REFERENCE TO RELATED APPLICATIONS

This application is based upon and claims the benefit of priority from prior Japanese Patent Application No. 2014-249591, filed Dec. 10, 2014, the entire contents of which are incorporated herein by reference.

### BACKGROUND OF THE INVENTION

1. Field of the Invention

The present invention relates to a commodity processing system.

2. Description of the Related Art

Recently a commodity identification device to identify a commodity based on image information acquired from a taken image of the commodity is being introduced widely. Such a commodity identification device is used for checkout at a cash register, which leads to an advantage of facilitating sales registration of fruits and vegetables, for example, to which a barcode is not attached.

JP 2014-92975 A, for example, describes a commodity identification device including: feature amount extraction means that extracts an appearance feature amount of a commodity based on image information acquired from a taken image of the commodity; similarity level calculation means that calculates a similarity level based on a comparison between the feature amount data of a predetermined recognition dictionary file and the appearance feature amount; and candidate output means that outputs a candidate of a target commodity based on the similarity level calculated by the similarity level calculation means.

In JP 2014-92975 A, the system is configured to make an operator (store staff) repeat the operation to pick up a commodity from a basket one by one and hold it over a reading window for taking an image and identification of the commodity by a commodity identification device, and then to put the commodity into another basket.

Another system of a belt conveyor type is known, in which a customer is placed commodities one by one on a belt conveyor, and then the customer puts the commodities after checkout into a bag. This can eliminate the necessity for an operator to pick up a commodity from a basket and move this to another basket.

Such a system is provided with a tunnel-like commodity identification device at some part along the belt conveyor, and is configured to perform sales registration of a commodity identified by the commodity identification device automatically, while making an operator perform an operation for sales registration of a commodity that is not identified by the commodity identification device (that cannot be determined as one commodity).

That is, this belt conveyor type system is configured to perform sales registration of a commodity that is conveyed by the belt conveyor, instead of making an operator pick up a commodity from a basket for sales registration. Such a system therefore has a problem of the difficulty for an operator to understand the correspondence relationship between the commodities (targets) being conveyed one by one and the commodities (targets) that are identified by the commodity identification device, and so such a system is inconvenient for operators.

### SUMMARY OF THE INVENTION

Then the present invention aims to enable an operator to understand the identification result of a target easily.

One aspect of the commodity processing system of the present invention includes: a commodity identification unit that identifies a target being conveyed in a predetermined conveyance direction by a conveyance unit as a commodity based on image information acquired from a taken image of the target and/or an identification label attached to the target; and a driving control unit that, when the commodity identification unit cannot identify the target as a commodity, stops conveyance of the target by the conveyance unit when the target moves to a predetermined position.

Another aspect of the commodity processing system of the present invention includes: an identification unit that identifies a target being conveyed in a predetermined conveyance direction by a belt driven at a belt conveyor and placed on the belt based on image information acquired from a taken image of the target and/or an identification label attached to the target; and a driving control unit that, when the identification unit cannot identify the target, stops driving of the belt when the target is conveyed by the belt conveyor to a position where a POS terminal is provided.

Still another aspect of the commodity processing system of the present invention includes: a belt conveyor that includes a belt on which a target is placed, and conveys the target by driving of the belt in a predetermined direction; an acquisition unit that acquires information on the target by taking an image of the target placed on the belt; an identification unit that identifies the target based on information acquired by the acquisition unit; and a driving control unit that, when the identification unit cannot identify the target, stops driving of the belt when the target is conveyed by the belt conveyor to a position where a POS terminal is provided.

The present invention enables an operator to understand the identification result of a target easily.

Advantages of the invention will be set forth in the description which follows, and in part will be obvious from the description, or may be learned by practice of the invention. The Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of the appearance of a commodity processing system according to Embodiment 1 of the present invention.

FIG. 2 shows the configuration of the commodity processing system.

FIG. 3 is a functional block diagram of the commodity identification device, including a microcomputer.

FIG. 4 is a flowchart illustrating the processing executed by the commodity identification device.

FIG. 5 is a flowchart illustrating the processing executed by the motor control circuit.

FIG. 6 is a flowchart illustrating the processing executed by the motor control circuit of the commodity processing system according to Embodiment 2 of the present invention.

### DETAILED DESCRIPTION OF THE INVENTION

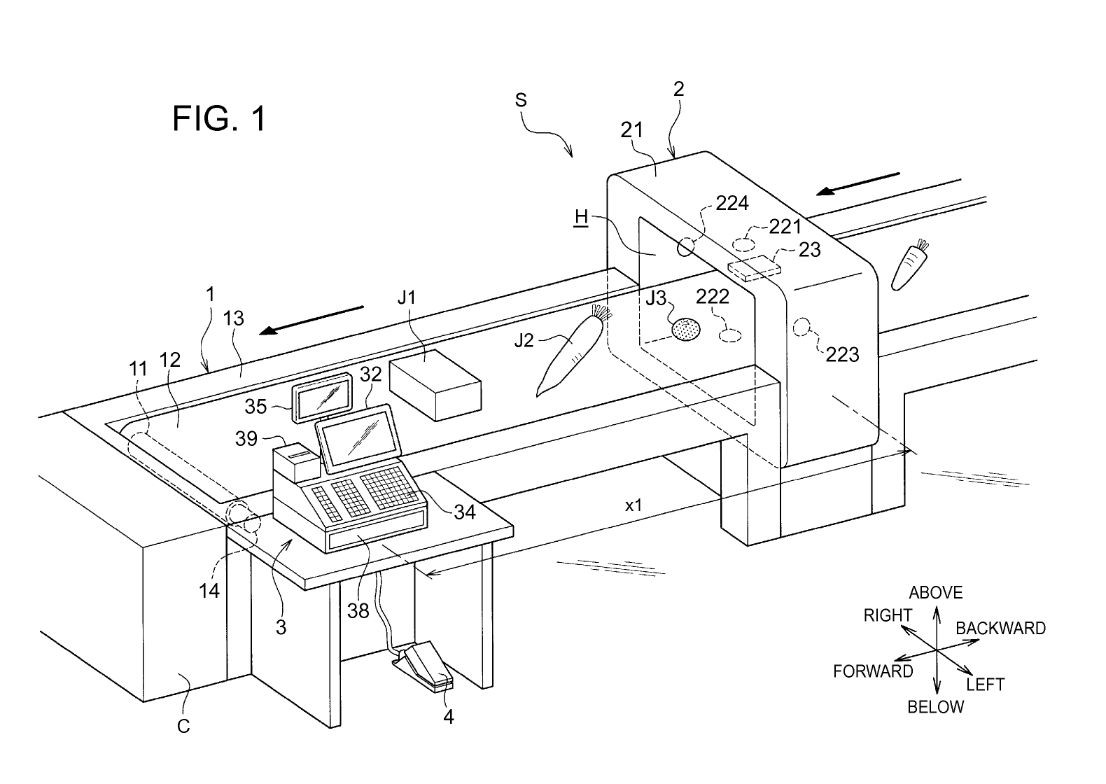

Referring to the drawings as needed, the following describes embodiments of the present invention in details. In the following descriptions, a commodity placed on a belt conveyor 1 (see FIG. 1) of a commodity processing system S (see FIG. 1) may be referred to as a “target”. As illustrated in FIG. 1, forward and backward, above and below, and left and right are defined.

### Embodiment 1

FIG. 1 is a perspective view of the appearance of a commodity processing system S according to Embodiment 1.

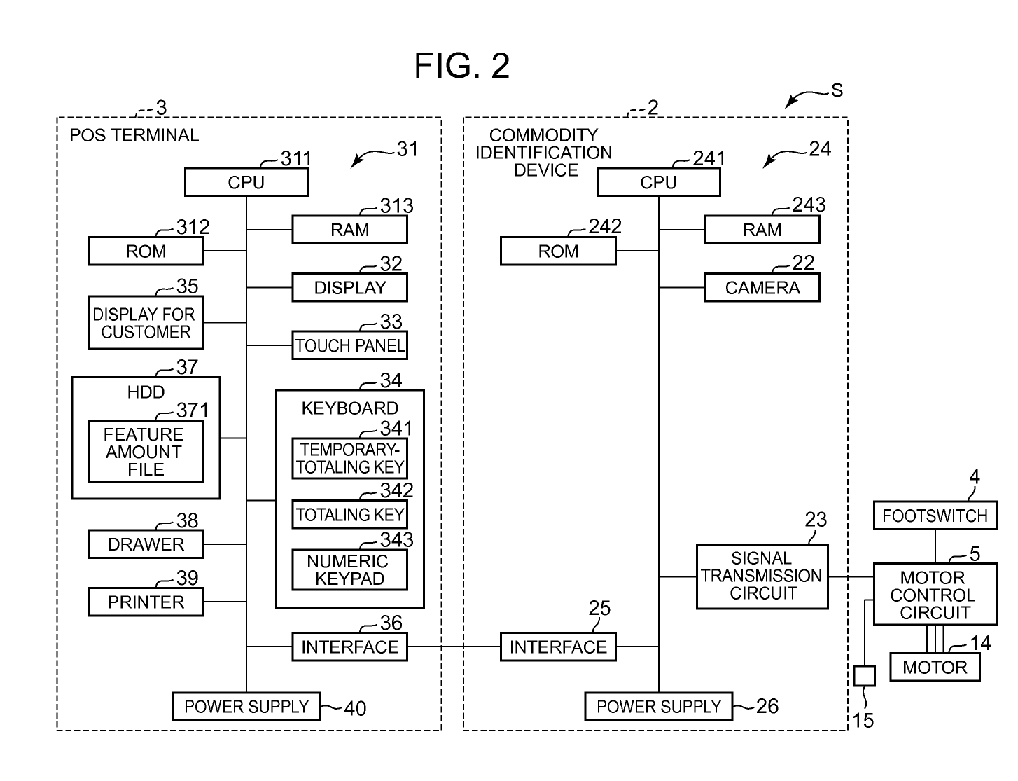

The commodity processing system S is a system for checkout of a commodity, for example, and includes a belt conveyor 1 (conveyance unit) to convey a commodity, a commodity identification device 2 (commodity identification unit) to identify a commodity, a POS terminal 3 for checkout or the like, a footswitch 4 (switching unit) to accept an operation (stepping-on) by an operator to the belt conveyor 1, and a motor control circuit 5 (driving control unit, see FIG. 2) to control driving/stopping of the belt conveyor 1.

FIG. 1 omits the illustration of an operator (store staff) and a customer, and an operator operates the POS terminal 3 on the left of the belt conveyor 1 (facing the viewer of the drawing) and a customer pays money, for example, on the right of the belt conveyor 1 (facing away from the viewer of the drawing).

A commodity to be purchased is picked up by the customer in a vicinity of an upstream end of the belt conveyor 1 from a basket (not illustrated), and is placed on a belt 12 one by one. Then, after payment of money therefor, the commodity is put into a bag by the customer on a table C.

The belt conveyor 1 is a device including a loop-like wide belt 12, and rotates the belt so as to convey a target as a commodity in a predetermined conveyance direction (see the arrows in FIG. 1).

The belt conveyor 1 includes: a plurality of rollers 11 that are arranged so that their axial lines are parallel to each other; the loop-like belt 12 stretched so as to slide on these rollers 11; a support 13 that supports the rollers 11 rotatably; a motor 14 that rotates the rollers 11, and a rotation angle sensor 15 (see FIG. 2) to detect the rotation angle (mechanical angle) of the motor 14.

Herein FIG. 1 illustrates, among the plurality of rollers 11, a carrier roller that is connected to a rotor of the motor 14 only, and omits the illustration of free rollers that rotate by a frictional force with the belt 12.

In the present embodiment, the belt 12 is a transparent (or semitransparent) belt having a property to transmit light. This is to enable taking an image of a target by cameras 221 to 224 described later from four directions of above, below, left and right. That is, such a light transmissive belt 12 is used so as to allow the camera 222 located below the belt 12 to take an image of a target from below as well.

The footswitch 4 in FIG. 1 is to switch the motor 14 between driving and stopping, i.e., the belt 12 between driving and stopping in response to the stepping-on operation by an operator, and the footswitch is located below the POS terminal 3. Every time the operator steps on the footswitch 4, driving and stopping of the motor 14 (that is, moving and stopping of a target on the belt 12) are switched by the motor control circuit 5 (see FIG. 2).

The motor control circuit 5 (see FIG. 2) controls the motor 14 that is connected to the roller 11 (the carrier roller) of the belt conveyor 1. The motor control circuit 5 is electrically connected to the rotation angle sensor 15, the footswitch 4 and a signal transmission circuit 23 described later. The motor control circuit 5 drives the motor 14 at a predetermined rotation speed based on a value detected by the rotation angle sensor 15.

The motor control circuit 5 has another function to switch the motor 14 between driving and stopping based on an identification result by the commodity identification device 2. Specifically, if the commodity identification device 2 cannot specify a commodity corresponding to the target (the commodity identification device 2 cannot identify the target as a commodity), the motor control circuit 5 stops the motor 14 (belt conveyor 1) when this target moves to a predetermined position in the conveyance direction (see the arrows in FIG. 1). The “predetermined position” may be a position of the POS terminal 3 in the conveyance direction, for example.

More simply, if any target cannot be specified as a commodity by the commodity identification device 2, when such a target moves to the front of the operator (near the POS terminal 3), the system is configured to stop the belt conveyor 1 by the motor control circuit 5. That is, although the operator does not step on the footswitch 4, the belt conveyor 1 is forcibly stopped, whereby the operator is informed that the commodity corresponding to the target (target in front of the operator) is not specified by the commodity identification device 2.

Herein the motor control circuit 5 stores (sets) distance information indicating the distance x1 (see FIG. 1) from the commodity identification device 2 to the installation position (predetermined position) of the POS terminal 3 as a traveling distance of the belt 12 from the detection of the target by the commodity identification device 2 to the stopping of the target.

On the contrary, when the commodity corresponding to the target is specified by the commodity identification device 2 (when the commodity identification device 2 successfully identifies the target as the commodity), the motor control circuit 5 does not stop the motor 14 (belt conveyor 1) even when this target moves to the predetermined position in the conveyance direction (see the arrows in FIG. 1).

The commodity identification device 2 in FIG. 1 is a device to identify a target being conveyed by the belt conveyor 1 in the conveyance direction (see the arrows in FIG. 1) as a commodity based on image information acquired from a taken image of the target. If a commodity corresponding to the target cannot be specified, the commodity identification device 2 outputs information as such or information indicating one or more candidate commodities to the POS terminal 3.

As illustrated in FIG. 1, the commodity identification device 2 includes a housing 21, the cameras 221 to 224 and the signal transmission circuit 23.

The housing 21 has a hole H and has a rectangular frame shape in a vertical cross sectional view. The belt 12 is disposed so as to penetrate through this hole H. That is, the commodity identification device 2 is disposed at some part along the belt conveyor 1 in the conveyance direction, and is configured to identify a target being conveyed on the belt conveyor 1.

The camera 221 in FIG. 1 takes an image of a target from above, and is provided at an upper wall of the housing 21. The camera 222 takes an image of the target from below, and is provided at a lower wall of the housing 21. The camera 223 takes an image of the target from left, and is provided at a left wall of the housing 21. The camera 224 takes an image of the target from right, and is provided at a right wall of the housing 21.

In this way, the present embodiment is configured so as to take an image of the target from four directions of above, below, left and right by the cameras 221 to 224. Although not illustrated in FIG. 1, light sources to apply light to a commodity from above, below, left and right are provided at the upper wall, the lower wall, the left wall and the right wall of the housing 21.

As described above, since the belt 12 has a light-transmissive property, light from the light source (not illustrated) provided at the lower wall passes through the belt 12 and is applied to the target, so as to allow the camera 222 to take an image of the target from below as well. In this context, no rollers 11 are provided in a range corresponding to the housing 21 in the conveyance direction. This can prevent the rollers 11 from interfering with taking an image of the target by the camera 222.

The cameras 221 to 224 may be color CCD (Charge-Coupled Device) image sensors, color CMOS (Complementary Metal Oxide Semiconductor) image sensors, or the like, which can take an image of a target at a predetermined frame rate (e.g., 30 times per second) in accordance with an instruction from a CPU 241 (see FIG. 2).

The signal transmission circuit 23 has a function to transmit a signal based on a result of “commodity identification processing” described later to the motor control circuit 5. Although described later in details, the result of the “commodity identification processing” executed by the commodity identification device 2 includes any one of the following (A), (B) and (C):

(A) a target can be specified as a commodity;

(B) although a target cannot be specified as a commodity, a candidate commodity can be listed; and

(C) a target cannot be specified as a commodity, and no candidate commodities can be listed.

When the result of the “commodity identification processing” corresponds to (B) or (C), the signal transmission circuit 23 transmits a stop signal to stop the belt conveyor 1 to the motor control circuit 5. A timing to stop the belt conveyor 1 is described later.

FIG. 2 shows the configuration of the commodity processing system S.

The commodity identification device 2 includes the housing 21 (see FIG. 1), the cameras 221 to 224 (in FIG. 2, they are referred to as a “camera 22”), and the signal transmission circuit 23 as stated above, as well as a microcomputer 24, an interface 25 and a power supply 26.

The microcomputer 24 controls the cameras 221 to 224 and the signal transmission circuit 23 of the commodity identification device 2, and includes the CPU 241, a ROM 242 and a RAM 243.

The CPU 241, the ROM 242 and the RAM 243 are connected via a bus, and they are configured so that a program is read out from the ROM 242 and is expanded in the RAM 243, and then the CPU 241 executes various types of processing. The CPU 241 is connected to the camera 22, the signal transmission circuit 23, the interface 25, and the power supply 26 via an internal bus or an input/output circuit (not illustrated).

The interface 25 is to allow for data exchange between the commodity identification device 2 and the POS terminal 3, and is connected to an interface 36 included in the POS terminal 3.

The power supply 26 is a power supply for devices included in the commodity identification device 2, and is connected to the devices as stated above.

The POS terminal 3 is configured so as to, when the commodity identification device 2 successfully identifies a target as a commodity, i.e., when the commodity identification device 2 specifies the target as one commodity (the above (A)), record information on sales registration of the commodity, such as a commodity class, a commodity name, or a unit price in a sales master file (not illustrated) for sales registration.

When the commodity identification device 2 fails to specify the target as one commodity (the above (B) or (C)), the POS terminal 3 is configured to perform sales registration of the commodity that is specified through an operation by an operator, and output a signal indicating that the commodity is specified to the motor control circuit 5.

As illustrated in FIG. 2, the POS terminal 3 includes a microcomputer 31, a display 32, a touch panel 33, a keyboard 34, a display for customer 35, the interface 36, a HDD (Hard Disk Drive) 37, a drawer 38, a printer 39 and a power supply 40.

The microcomputer 31 controls devices included in the POS terminal 3, and includes a CPU 311, a ROM 312 and a RAM 313. The CPU 311, the ROM 312 and the RAM 313 are connected via a bus, and they are configured so that a program is read out from the ROM 312 and is expanded in the RAM 313, and then the CPU 311 executes various types of processing.

The CPU 311 is connected to the display 32, the touch panel 33, the keyboard 34, the display for customer 35, the interface 36, the HDD 37, the drawer 38, the printer 39 and the power supply 40 via an internal bus or an input/output circuit (not illustrated).

The display 32 displays information input from the commodity identification device 2 via the interface 36 or information on a commodity based on an operation by an operator using the touch panel 33 or the like and in accordance with an instruction from the CPU 311.

The touch panel 33 accepts an operation by an operator relating to information displayed on the display 32.

The keyboard 34 includes a temporary-totaling key 341 that is pushed down for temporary totaling (temporary counting) of the sales registration, a totaling key 342 that is pushed down for totaling (counting) of the sales registration, and a numeric keypad 343 including numeric keys and various mathematical operator keys.

The display for customer 35 displays information on sales registration for a customer in accordance with an instruction from the CPU 311.

The interface 36 is to allow for data exchange between the commodity identification device 2 and the POS terminal 3, and is connected to the interface 25 included in the commodity identification device 2.

The HDD 37 stores programs and various files. All or a part of the programs and various files stored in the HDD 37 is copied to the RAM 313 at the booting of the POS terminal 3, and then the programs copied to the RAM 313 are executed by the CPU 311. The HDD 37 stores a feature amount file 371 on various commodities. The feature amount file 371 is a commodity file containing information about each of commodities that are to be displayed and sold at the store, the information containing association of information to identify the commodity or the price of the commodity with reference image information on the commodity.

The drawer 38 is to keep cash or the like therein, and is configured to open in response to a predetermined operation using the keyboard 34.

The printer 39 prints the details of a transaction relating to a commodity on a receipt in accordance with an instruction from the CPU 311.

The power supply 40 is a power supply for the devices included in the POS terminal 3, and is connected to the devices described above.

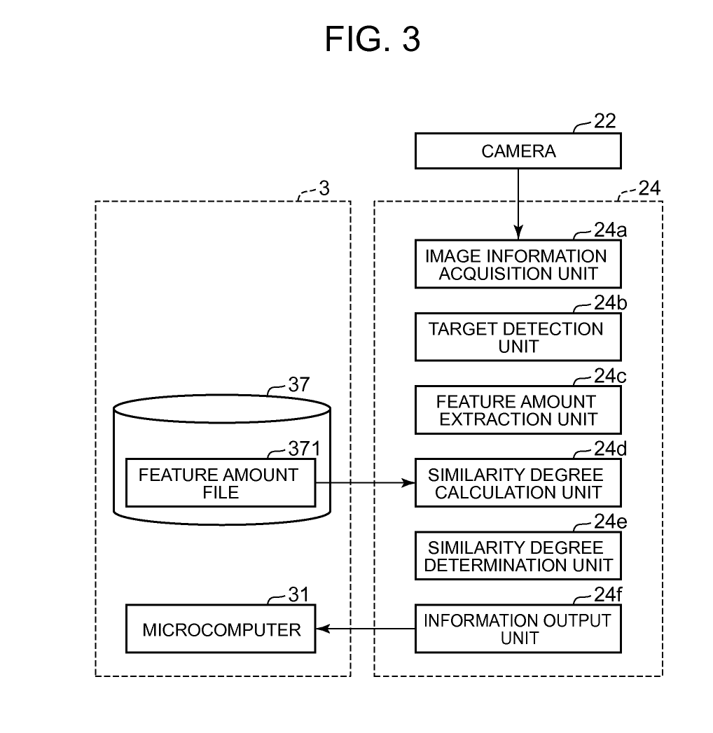

FIG. 3 is a functional block diagram of the commodity identification device 2, including the microcomputer 24.

The microcomputer 24 includes an image information acquisition unit 24a, a target detection unit 24b, a feature amount extraction unit 24c, a similarity level calculation unit 24d, a similarity level determination unit 24e, and an information output unit 24f. The functions of these units described are implemented through the execution of a program stored in the ROM 242 (see FIG. 2) by the CPU 241 (see FIG. 2) of the microcomputer 24.

The image information acquisition unit 24a outputs an imaging ON signal to the camera 22 (the cameras 221 to 224 in FIG. 1), and acquires frame images of a target obtained through the imaging one by one and stores them in the RAM 243 (see FIG. 2).

The target detection unit 24b detects all or a part of the target included in the frame images acquired by the image information acquisition unit 24a based on pattern matching or the like. For instance, the target detection unit 24b binarizes these frame images to extract their outline, and detects the target based on the outline.

The feature amount extraction unit 24c extracts a feature amount from the frame images. Specifically the feature amount extraction unit 24c extracts, from the frame images in which the target is detected, a feature amount, such as the color, the shape (including irregularities at the surface), and the size of the target, as image information.

Such recognition of a target included in the images is called generic object recognition. According to Keiji YANAI “The current state and future directions on generic object recognition”, the current state of generic object recognition is surveyed in terms of datasets and evaluation benchmarks as well as the methods, and its future directions also are discussed.

Keiji Yanai “The current state and future directions on generic object recognition”, [online], Journal of Information Processing Society, Nov. 15, 2007, Vol. 48, No. SIG16, pp 1 to 24, [Search on Nov. 27, 2014 (Heisei 26)], Internet <URL: http://mm.cs.uec.ac.jp/IPSJ-TCVIM-Yanai.pdf>

The following document also describes a technique to perform generic object recognition by performing an area-division of an image for each object.

Jamie Shotton et al., “Semantic Texton Forests for Image Categorization and Segmentation”, Computer Vision and Pattern Recognition, 2008. CVPR 2008. IEEE Conference on, [Search on Nov. 27, 2014 (Heisei 26)], Internet <URL:http://mi.eng.cam.ac.uk/˜cipolla/publications/inproceedings/2008-CVPR-semantic-texton-forests.pdf>

The feature amount extraction unit 24c extracts a feature amount for each of the frame images in four directions that are acquired through the imaging of a target from above, below, left and right by the cameras 221 to 224 (see FIG. 1).

The similarity level calculation unit 24d refers to and compares image information, such as a feature amount, extracted by the feature amount extraction unit 24c with reference image information of each commodity stored in the HDD 37, and calculates a similarity level of the target with each commodity. Herein, the “similarity level” is a value indicating how the target is similar to the commodity. When the image of the target matches the image of a commodity perfectly, the similarity level is 100%. When the image of the target is greatly different from the image of a commodity, the similarity level is low.

The similarity level determination unit 24e has a function to specify a commodity based on the similarity level calculated by the similarity level calculation unit 24d, or to list one or a plurality of candidate commodities. The determination result by the similarity level determination unit 24e corresponds to any one of A (a commodity can be specified), B (candidate commodities can be listed) and C (no commodity can be specified, and no candidate commodities also can be listed) as stated above.

The information output unit 24f outputs information based on the determination result by the similarity level determination unit 24e to the microcomputer 31 of the POS terminal 3. Specifically when a commodity corresponding to the target is specified, the information output unit 24f outputs a commodity ID or the like of the specified commodity to the POS terminal 3. In this case, the POS terminal 3 performs sales registration of the commodity.

When no commodity corresponding to the target is specified but a candidate commodity for the target is listed, the information output unit 24f outputs a commodity ID or the like of the candidate commodity to the POS terminal 3. In this case, the POS terminal 3 performs sales registration of a candidate commodity that is selected through an operation by the operator.

When no commodity corresponding to the target is specified and no candidate commodity for the target is listed, the information output unit 24f outputs information as such to the POS terminal 3. In this case, the POS terminal 3 performs sales registration of a commodity that is input through an operation by the operator.

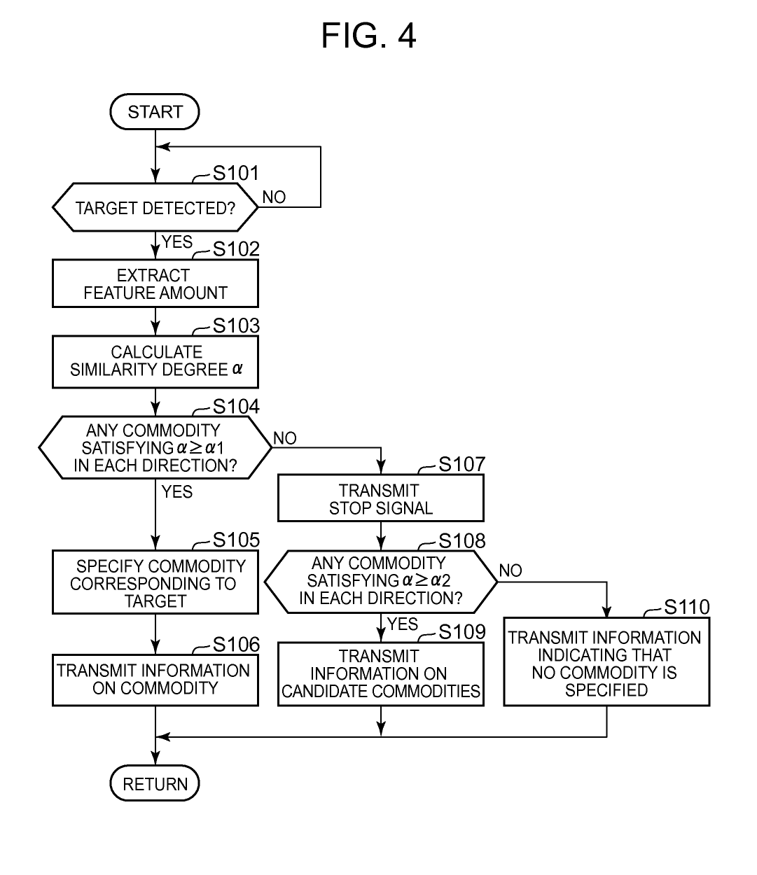

FIG. 4 is a flowchart illustrating the processing executed by the commodity identification device 2.

During the processing of FIG. 4, a target (a commodity) is conveyed on the belt conveyor 1.

At Step S101, the commodity identification device 2 determines whether the target detection unit 24b detects the target or not. As described above, the commodity identification device 2 detects the target from frame images acquired from a taken image of the target by pattern matching or the like.

When the target is detected (S101→Yes), the processing by the commodity identification device 2 proceeds to Step S102. On the contrary, when no target is detected (S101→No), the commodity identification device 2 repeats the processing at Step S101.

At Step S102, the commodity identification device 2 makes the feature amount extraction unit 24c extract a feature amount from frame images of the target. That is, the commodity identification device 2 extracts, from the frame images of the target acquired from a taken image, a feature amount, such as the color, the shape, and the size of the target, as image information. As described above, for each of the frame images in four directions of the above, below and left and right acquired by taking an image of the target by the cameras 221 to 224, image information based on object recognition is extracted.

At Step S103, the commodity identification device 2 makes the similarity level calculation unit 24d calculate a similarity level α between the image information on the target imaged by the cameras 221 to 224 and reference image information on each commodity registered in the feature amount file 371 (see FIG. 3).

The commodity identification device 2 calculates a similarity as follows, for example. The commodity identification device 2 refers to and compares image information (feature amount) based on a frame image acquired by taking an image of the target from above by the camera 221 with reference image information on each commodity stored in the feature amount file 371 to calculate the similarity α. The feature amount file 371 stores reference image information corresponding to the four directions of the above, below and left and right for each of the commodities.

Next, the commodity identification device 2 specifies, for the reference image information on one commodity in the four directions, one piece of such information having a highest similarity level (direction) with the image information on the target acquired by taking an image from above. Then the commodity identification device 2 refers to and compares the reference image information corresponding to the other directions (when the direction having a highest similarity level is the above, then the below, left and right) of below, left and right with image information (feature amount) based on the frame images acquired by taking an image of the target from the lower, left and right, to calculate similarity levels in these directions. The commodity identification device 2 performs such processing for each commodity.

A customer typically places targets (commodities) one by one on the belt 12 with less attention given to the orientation of the targets. Therefore, if a similarity level is calculated based on the result of an image taken by only one camera, the similarity level with a commodity corresponding to the target may be lowered in some ways of placing the target on the belt.

On the contrary, according to the present embodiment, a similarity level corresponding to each direction can be calculated based on image information acquired from a taken image of the target from four direction of the above, below, left and right. Therefore, the accuracy of the determination processing (S104, S108) of a similarity level described below can be increased.

At Step S104, the commodity identification device 2 makes the similarity level determination unit 24e determine whether there is any commodity having similarity levels of a first threshold α1 (e.g., 70%) or more for all of the four directions of the above, below, left and right. The first threshold α1 is a preset threshold that is a criterion for determination to specify a commodity corresponding to the target.

When there is a commodity having similarity levels of the first threshold α1 or more for all of the four directions of the above, below, left and right (S104→Yes), the processing by the commodity identification device 2 proceeds to Step S105.

At Step S105, the commodity identification device 2 specifies a commodity corresponding to the target. Herein when one commodity having the similarity levels of the first threshold α1 or more is specified, the commodity identification device 2 specifies the target as this commodity. When there is a plurality of commodities having the similarity levels of the first threshold α1 or more, the commodity identification device 2 specifies the commodity giving a maximum similarity level as the commodity corresponding to the target.

At Step S106, the commodity identification device 2 makes the information output unit 24f transmit commodity information (such as a commodity ID) on the commodity specified at Step S105 to the POS terminal 3. Thereby, sales registration of the target detected at Step S101 is performed as the commodity specified at Step S105.

On the contrary, when there is no commodity having similarity levels of the first threshold α1 or more for all of the four directions of the above, below, left and right at Step S104 (S104→No), the processing by the commodity identification device 2 proceeds to Step S107.

At Step S107, the commodity identification device 2 makes the signal transmission circuit 23 (see FIG. 2) output a stop signal to stop the belt conveyor 1 to the motor control circuit 5 (see FIG. 2). The operation of the motor control circuit 5 when receiving a stop signal is described later.

At Step S108, the commodity identification device 2 makes the similarity level determination unit 24e determine whether there is any commodity having similarity levels of a second threshold α2 (e.g., 50%) or more for all of the four directions of the above, below, left and right. The second threshold α2 is a preset threshold that is a criterion for determination whether or not to list a candidate commodity for the target.

When there is a commodity having similarity levels of the second threshold α2 or more for all of the four directions of the above, below, left and right (S108→Yes), the processing by the commodity identification device 2 proceeds to Step S109.

At Step S109, the commodity identification device 2 makes the information output unit 24f transmit information (such as a commodity ID) on the candidate commodity specified at Step S108 to the POS terminal 3. Thereby, the display 32 of the POS terminal 3 displays a selection screen of the candidate commodities (when one candidate commodity is to be displayed, a confirmation screen).

When there is no commodity having similarity levels of the second threshold α2 or more for all of the four directions of the above, below, left and right at Step S108 (S108→No), the processing by the commodity identification device 2 proceeds to Step S110. “Commodity identification processing” (commodity identification step) to identify a target being conveyed on the belt conveyor 1 in the predetermined conveyance direction as a commodity based on image information acquired through a taken image of the target includes the processing at Steps S102 to S105 and S108.

At Step S110, the commodity identification device 2 makes the information output unit 24f transmit, to the POS terminal 3, information indicating that no commodity is specified. Then, the display 32 of the POS terminal 3 displays that no commodity is specified.

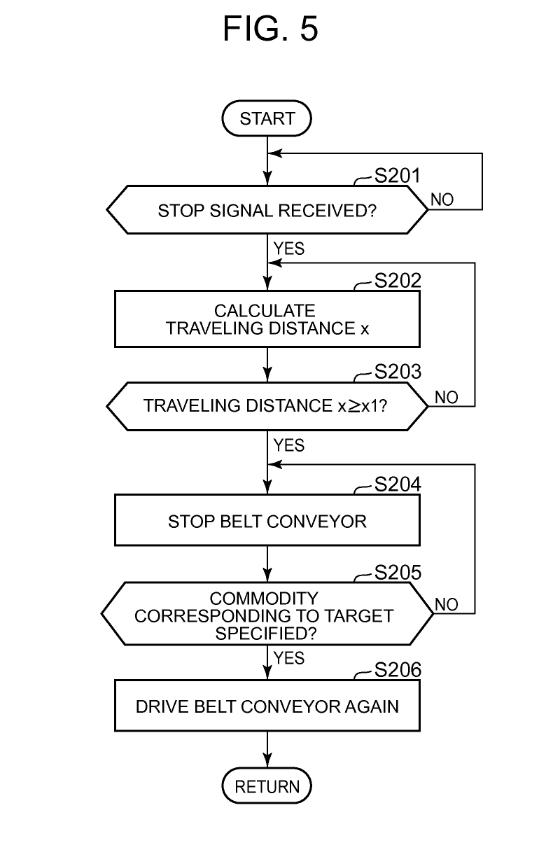

FIG. 5 is a flowchart illustrating the processing executed by the motor control circuit 5 (see FIG. 2).

At Step S201, the motor control circuit 5 determines whether it receives a stop signal from the commodity identification device 2 or not. As described above, the stop signal is output from the commodity identification device 2 to the motor control circuit 5 when no commodity is specified corresponding to the target (S107, see FIG. 4).

When the motor control circuit 5 does not receive a stop signal from the commodity identification device 2 (S201→No), it repeats the processing at Step S201. That is, while commodities are specified for the targets being conveyed one by one on the belt conveyor 1 (S104→Yes, S105, see FIG. 4), the motor control circuit 5 continues to drive the belt conveyor 1. In this case, the operator does not step on the footswitch 4 (does not stop the belt conveyor 1), and visually checks the display 32 about the sales registration of the targets passing by in front.

When a stop signal is received from the commodity identification device 2 at S201 (S201→Yes), the processing by the motor control circuit 5 proceeds to Step S202.

At Step S202, the motor control circuit 5 calculates a traveling distance x of the belt 12 (i.e., the traveling distance of the target) with reference to the timing when the commodity identification device 2 detects the target. That is, the motor control circuit 5 calculates the traveling distance x of the belt 12 based on a detected value of the rotation angle sensor 15 (see FIG. 2) with reference to the rotation angle of the motor 14 when receiving the stop signal at Step S201.

At Step S203, the motor control circuit 5 determines whether the traveling distance x calculated at Step S202 is a predetermined distance x1 or more. This predetermined distance x1 (see FIG. 1) is a threshold as a criterion for determination as to whether the target to be identified by the commodity identification device 2 moves to the front of the operator (near the POS terminal 3) or not as stated above.

When the traveling distance x of the belt 12 is the predetermined distance x1 or more (S203→Yes), the processing by the motor control circuit 5 proceeds to Step S204. In this case, the target to be identified by the commodity identification device 2 (the target that is not specified as a commodity) moves near the POS terminal 3 in the conveyance direction.

When the traveling distance x of the belt 12 is less than the predetermined distance x1 (S203→No), the processing by the motor control circuit 5 returns to Step S202. In this case, the target to be identified by the commodity identification device 2 travels downstream toward the POS terminal 3.

At Step S204, the motor control circuit 5 stops the belt conveyor 1. For instance, when a target J1 (see FIG. 1) that is not specified as a commodity travels near the POS terminal 3, the motor control circuit 5 stops the belt conveyor 1. Thereby, the operator can easily notice that the target J1 in front is not specified as a commodity.

Driving control processing (driving control step) to, when a target is not specified as a commodity corresponding thereto, stop the belt conveyor 1 when the target travels to the predetermined position in the conveyance direction includes the processing at Steps S201 to S204.

At Step S205, the motor control circuit 5 determines whether a commodity corresponding to the target is specified or not through the operation by the operator. That is, the motor control circuit 5 determines whether a commodity is specified or not through the operation by the operator to select one of the candidate commodities displayed on the display 32 (see FIG. 1) or to input a commodity ID. The POS terminal 3 is configured to output a signal indicating that a commodity is specified to the motor control circuit 5.

When a commodity corresponding to the target is specified (S205→Yes), the processing by the motor control circuit 5 proceeds to Step S206. On the contrary, when a commodity corresponding to the target is not specified (S205→No), the processing by the motor control circuit 5 returns to Step S204. That is, the motor control circuit 5 keeps the belt conveyor 1 in a stop state until a commodity corresponding to the target is specified through the operation by the operator.

At Step S206, the motor control circuit 5 drives the belt conveyor 1 again. That is, when a commodity corresponding to the target is specified through the operation by the operator (S205→Yes), the motor control circuit 5 drives the belt conveyor 1 again to move the target downstream (S206). Following the processing at Step S206, the processing by the motor control circuit 5 returns to “START” (RETURN).

### <Advantageous Effects>

In the present embodiment, while commodities are specified for targets conveyed one by one (S104→Yes, S105), the belt conveyor 1 is continuously driven (S201→No). Therefore, an operator just has to visually check the display 32 of the POS terminal 3 about the result of automatic sales registration, and does not have to perform the operation such as picking up a target and holding it over the camera. According to the present embodiment, workload on the operator can be greatly reduced as compared with a conventional system.

When a commodity corresponding to the target is not specified by the commodity identification device 2 (S104→No, S107), the belt conveyor 1 is forcibly stopped when this target moves near the POS terminal 3 (to the front of the operator) (S204). Therefore, the operator can easily understand the correspondence relationship between the commodities displayed on the display 32 (information on candidate commodities or a failure of identification) and targets that are identified by the commodity identification device 2. In this way, the present embodiment can provide the commodity processing system S that allows the operator to easily understand the identification result of the targets.

Further when the belt conveyor 1 is stopped, the operator can notice about the target in front of the operator that the target is not sales-registered.

Moreover, in the present embodiment, the system is configured so as to take an image of a target from four directions of the above, below, left and right, and to identify the target based on image information acquired from a taken image of the target. Therefore as compared with the case of taking an image of a target from one direction, the commodity corresponding to the target can be specified precisely. Herein, it is rare that a customer gives attention to the orientation of the target when they put the target on the belt 12 so that the feature of the target becomes obvious during taking an image. According to the present embodiment, since an image of the target is taken from four directions, the commodity corresponding to the target can be specified precisely irrespective of the orientation of the target on the belt 12.

### Embodiment 2

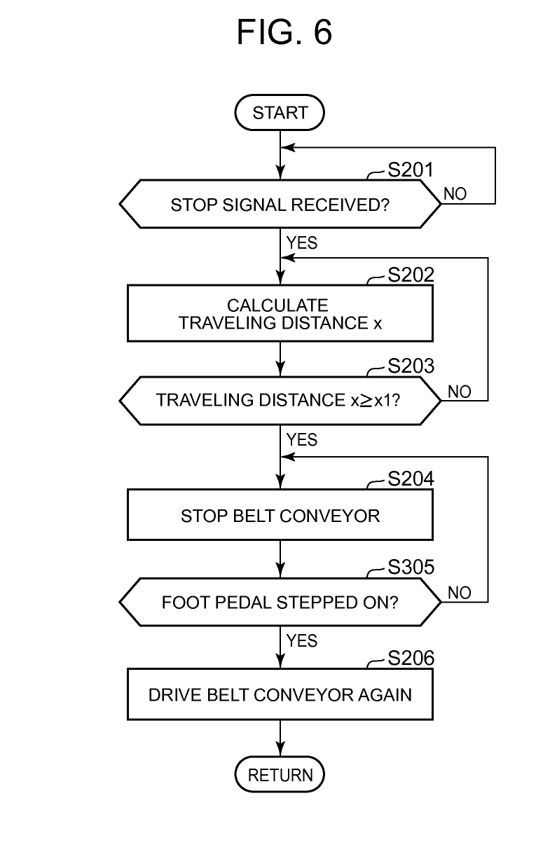

Embodiment 2 is different from Embodiment 1 in that, in the case where a commodity corresponding to a target is not specified by the commodity identification device 2, and when the operator steps on the footswitch 4, the belt conveyor 1 is driven again. That is, in Embodiment 1, when the commodity corresponding to the target is specified through the operation by the operator, the belt conveyor 1 is driven again (S205→Yes, S206, see FIG. 5). Whereas, Embodiment 2 is different in that, when the operator steps on a footswitch 4, the belt conveyor 1 is driven again (S305→Yes, S206, see FIG. 6).

The configuration of the commodity processing system S (see FIG. 1, FIG. 2 and FIG. 3) and the processing executed by the commodity identification device 2 (see FIG. 4) are the same as in Embodiment 1. The following therefore describes a part different from Embodiment 1 (the processing executed by the motor control circuit 5), and the descriptions are omitted for a duplicated part with Embodiment 1.

FIG. 6 is a flowchart illustrating the processing executed by the motor control circuit 5 of the commodity processing system S according to Embodiment 2. The same step numbers are assigned to the duplicated parts with the processing described in Embodiment 1 (see FIG. 5).

At Step S204, after stopping the belt conveyor 1, the processing by the motor control circuit 5 proceeds to Step S305. Assume that, at this time, a target for which a commodity cannot be specified by the commodity identification device 2 is present in front of the operator (near the POS terminal 3 in the conveyance direction).

At Step S305, the motor control circuit 5 determines whether the operator steps on the footswitch 4 (see FIG. 1) or not. The operator usually selects a commodity corresponding to the target, for example, for sales registration, and then steps on the footswitch 4 to drive the belt conveyor 1 again. That is, it can be said that a determination as to whether the commodity corresponding to the target is specified or not is performed indirectly at Step S305.

When the footswitch 4 is not stepped on at Step S305, (S305→No), the processing by the motor control circuit 5 returns to Step S204. That is, while the operator does not step on the footswitch 4, the motor control circuit 5 keeps stopping the belt conveyor 1.

When the operator steps on the footswitch 4 (S305→Yes), at Step S206, the motor control circuit 5 drives the belt conveyor 1 again.

### <Advantageous Effects>

In the present embodiment, after stopping the belt conveyor 1 (S204), when the operator steps on the footswitch 4 (S305→Yes), the motor control circuit 5 cancels the stopping of the belt conveyor 1 and drives it again (S206). Thereby, a commodity in front of the operator and after sales registration is allowed to move downstream, and so commodity identification processing by the commodity identification device 2 and sales registration by the POS terminal 3 can be performed to targets that are conveyed one by one on the belt conveyor 1.

### MODIFIED EXAMPLES

That is the description of the embodiments of the commodity processing system S according to the present invention, and the present invention is not limited to these descriptions, which are susceptible to various modifications.

For instance, in these embodiments, an image of a target is taken from four directions of the above, below, left and right by the cameras 221 to 224 (see FIG. 1), which is not a limiting example. For instance, a target may be identified based on a result of an image taken by one camera that is provided so as to look down at the target diagonally.

Alternatively, an image of a target may be taken from two directions (e.g., above and right) or three directions (e.g., above, right and left), and the target may be identified based on a result of the image taken. When an image of a target is not taken from below, the belt 12 may be a normal belt that does not have a light-transmissive property.

In these embodiments, a target is identified based on image information (feature amount) acquired from a taken image of the target, which is not a limiting example. For instance, instead of the commodity identification device 2, a barcode scanner (commodity identification unit, not illustrated), by which a barcode (identification label) attached to the target is read, may be disposed at some part along the belt conveyor 1. In this case, the motor control circuit 5 keeps the driving of the belt conveyor 1 for a target whose barcode is read by the barcode scanner so that such a target just passes by in front of the POS terminal 3. On the contrary, for a target whose barcode is not read, the belt conveyor 1 is stopped when such a target moves near the POS terminal 3. Thereby, the operator can understand a target whose barcode is read (target passing by) and a target whose barcode cannot be read (target stopping in front) correctly.

Alternatively the commodity identification device 2 may be provided with a barcode scanner as well, and may be configured to identify a target based on image information acquired from a taken image of the target and/or based on a barcode (identification label) attached to the target. In this configuration, if different commodities are specified by based on a barcode and based on image information, the commodity specified by the barcode is preferentially selected preferably because of its high certainty.

These embodiments are configured so as to, when a target whose commodity cannot be specified by the commodity identification device 2 moves to the front of the operator, stop the belt conveyor 1, and in addition to this, a result of the identification by the commodity identification device 2 may be noticed to the operator. For instance, an indication lamp (alarm unit, not illustrated) may be disposed near the POS terminal 3 in the conveyance direction, and when the belt conveyor 1 is forcibly stopped, the indication lamp may be lit (i.e., so as to notice the result of identification). Thereby, the operator can confirm the stopping of the belt conveyor 1, which is based on the result of identification by the commodity identification device 2, and so they can keep the operation without worry.

Embodiment 1 and Embodiment 2 may be combined so that, after stopping the belt conveyor 1 (S204), when a commodity corresponding to the target is specified through the operation by the operator (S205→Yes) or when the operator steps on the footswitch 4 (S305→Yes), the belt conveyor 1 may be driven again.

The above embodiments describe the case where the commodity processing system S is used for sales registration of commodities, which is not a limiting example. For instance, the commodity processing system S of these embodiments may be used in a system to classify or manage, for example, commodities using a belt conveyor.

The processing described in these embodiments (FIG. 4 to FIG. 6, for example) may be executed by another computer using a program. The program may be offered via a communication line, or may be written on a recording medium, such as a CD-ROM, for distribution.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A commodity processing system, comprising:
a commodity identification unit that identifies a target being conveyed in a predetermined conveyance direction by a conveyance unit as a commodity based on image information acquired from a taken image of the target and/or an identification label attached to the target; and
a driving control unit that, when the commodity identification unit cannot identify the target as a commodity, stops conveyance of the target by the conveyance unit when the target moves to a predetermined position.

2. The commodity processing system according to claim 1, wherein when the commodity identification unit can identify the target as a commodity, the driving control unit does not stop conveyance of the target by the conveyance unit even when the target moves to the predetermined position.

3. The commodity processing system according to claim 1, wherein after stopping conveyance of the target by the conveyance unit, the driving control unit resumes conveyance by the conveyance unit in accordance with a predetermined input operation by an operator.

4. The commodity processing system according to claim 1, further comprising a POS terminal disposed so as to face the predetermined position.

5. A commodity processing system, comprising:
an identification unit that identifies a target being conveyed in a predetermined conveyance direction by a belt driven at a belt conveyor and placed on the belt based on image information acquired from a taken image of the target and/or an identification label attached to the target; and
a driving control unit that, when the identification unit cannot identify the target, stops driving of the belt when the target is conveyed by the belt conveyor to a position where a POS terminal is provided.

6. The commodity processing system according to claim 5, wherein when the identification unit can identify the target, the driving control unit does not stop driving of the belt even when the target is conveyed by the belt conveyor to the position where the POS terminal is provided.

7. The commodity processing system according to claim 5, wherein after stopping driving of the belt, the driving control unit resumes driving of the belt in accordance with an input operation by an operator to the POS terminal.

8. The commodity processing system according to claim 5, wherein the identification unit is disposed so as to cover the belt partially.

9. The commodity processing system according to claim 5, wherein the identification unit is configured so as to enable taking an image of the target from a plurality of directions.

10. The commodity processing system according to claim 5, wherein the belt is made of a light-transmissive material, and the identification unit is configured so as to enable taking an image of the target via the belt.

11. The commodity processing system according to claim 5, wherein the identification unit transmits a result of identification of the target to the POS terminal.

12. The commodity processing system according to claim 11, wherein the POS terminal performs sales registration of the target based on a result of identification of the target received from the identification unit.

13. A commodity processing system, comprising:
a belt conveyor that includes a belt on which a target is placed, and conveys the target by driving of the belt in a predetermined direction;
an acquisition unit that acquires information on the target by taking an image of the target placed on the belt;
an identification unit that identifies the target based on information acquired by the acquisition unit; and
a driving control unit that, when the identification unit cannot identify the target, stops driving of the belt when the target is conveyed by the belt conveyor to a position where a POS terminal is provided.

14. The commodity processing system according to claim 13, wherein when the identification unit can identify the target, the driving control unit does not stop driving of the belt even when the target is conveyed by the belt conveyor to the position where the POS terminal is provided.

15. The commodity processing system according to claim 13, wherein after stopping driving of the belt, the driving control unit resumes driving of the belt in accordance with an input operation by an operator to the POS terminal.

16. The commodity processing system according to claim 13, wherein the acquisition unit is configured so as to enable taking an image of the target from a plurality of directions.

17. The commodity processing system according to claim 13, wherein the belt is made of a light-transmissive material, and the acquisition unit is configured so as to enable taking an image of the target via the belt.

18. The commodity processing system according to claim 13, wherein the POS terminal is disposed downstream of the acquisition unit in the conveyance direction.

19. The commodity processing system according to claim 13, wherein the identification unit transmits a result of identification of the target to the POS terminal.

20. The commodity processing system according to claim 19, wherein the POS terminal performs sales registration of the target based on a result of identification of the target received from the identification unit.
